(19) United States
(12) Patent Application Publication
(10) Pub. No.: US 2026/0186222 A1
(43) Pub. Date: Jul. 2, 2026

(54) GLASS-BASED PHOTONIC BRIDGE WITH MICRO-HOLE(S)

(71) Applicant: CORNING RESEARCH & DEVELOPMENT CORPORATION, CORNING, NY (US)

(72) Inventors: Lars Martin Otfried Brusberg, Corning, NY (US); Tim Grygiel, Schoenebeck (DE)

(21) Appl. No.: 19/547,101

(22) Filed: Feb. 23, 2026

Related U.S. Application Data
(63) Continuation of application No. PCT/US2024/043156, filed on Aug. 21, 2024.
(60) Provisional application No. 63/535,528, filed on Aug. 30, 2023.

(51) Int. Cl. G02B 6/43; G02B 6/42

(52) U.S. Cl. CPC G02B 6/43; G02B 6/4244; G02B 6/4245

(57) ABSTRACT

Devices, methods, and assemblies are provided that include glass-based photonic bridges. An example glass-based photonic bridge defines a first side and a second side and includes optical waveguide(s) on the first side. One or more micro-holes extend through the glass-based photonic bridge from the first side to the second side and are configured to receive an electrical connection material therein for electrical connection between a first substrate adjacent the first side and a second substrate adjacent the second side.

### RELATED APPLICATIONS

This application is a continuation of International Patent Application No. PCT/US2024/043156 filed on August 21, 2024, which claims the benefit of priority of U.S. Provisional Application Serial No. 63/535,528 filed on August 30, 2023, the content of which is relied upon and incorporated herein by reference in its entirety.

### FIELD

Example embodiments of the present disclosure generally relate to glass-based photonic bridges and, more particularly to, glass-based photonic bridges with one or more micro-holes.

### BACKGROUND

Currently, fiber optical interconnects between two photonic integrated circuits (PIC) are realized via optical fibers. Known limitations of optical interconnects occur when a waveguide pitch is limited by fiber diameter. In addition, limitations occur when fiber termination takes up space, which requires a minimum length between PICs. Another known limitation occurs when tolerances of assemblies negatively impact connection losses.

For future systems, where optical interconnects are becoming shorter and higher density, optical fibers will likely not be scalable. Accordingly, new optical interconnect solutions are needed, particularly in the area of chip-to-chip communication and photonic multi-chip-modules (also referred to as “photonic MCM”).

Current solutions have high packaging complexity due to having a combined mating process of optical and electrical connections. Further, in current solutions, electrical and optical connections are located on different physical planes, which causes a small tolerance window for process and material variations.

Improvements in the foregoing are desired.

### BRIEF SUMMARY

Some example embodiments of the present disclosure include glass-based photonic bridges with micro-hole(s) that are configured to receive electrical connection material such as solder balls, bumps, and/or copper pillars. Such glass-based photonic bridges also include waveguide(s) for optical interconnection between photonic integrated circuits (PICs) (or dies) in combination with the micro-hole(s). This enables electronic packaging techniques that do not require advanced features at a PIC (or die), such as small pitch through silica vias (TSVs). Further, such glass-based photonic bridges decouple optical and electrical connection processes and enable, e.g., high volume wafer level solder ball attachment.

Various glass-based photonic bridges disclosed herein are a thin component for potential use as an embedded solution. In some embodiments, the glass-based photonic bridge can be implemented by wafer bonding. Moreover, using an ultra-thin glass substrate including waveguides in combination with micro-holes can enable mass production assembly technologies like wafer balling and flip chip, without the requirement of high density TSVs at a PIC level.

Some example embodiments include a glass-based photonic bridge having optical waveguide(s) disposed on a first side and micro-hole(s) extending between the first side and a second side. The micro-hole(s) are configured to receive an electrical connection material therein for electrical connection between a first substrate adjacent the first side and a second substrate adjacent the second side. For example, the first substrate may be a wafer including a first die and a second die or may be a first die and a second die alone (e.g., without a wafer), and the second substrate may be an organic printed circuit board.

In an example embodiment, a glass-based photonic bridge is provided. The glass-based photonic bridge includes a first side, a second side opposite the first side, at least one optical waveguide disposed on the first side, and at least one micro-hole extending between the first side and the second side, the at least one micro-hole being configured to receive an electrical connection material therein extending through the at least one micro-hole for electrical connection between a first substrate adjacent the first side and a second substrate adjacent the second side.

In some embodiments, the glass-based photonic bridge may be configured to be packaged with at least one substrate and at least one of a wafer or a die.

In some embodiments, the first substrate may define a footprint, and the at least one micro-hole may be positioned within the footprint when the electrical connection material is received by the at least one micro-hole for electrical connection between the first substrate and the second substrate.

In some embodiments, the at least one micro-hole may be two micro-holes that are spaced apart, and the at least one optical waveguide may be positioned between the two micro-holes.

In some embodiments, the glass-based photonic bridge may be flexible.

In some embodiments, the at least one micro-hole may be a plurality of micro-holes.

In some embodiments, the electrical connection material may be one or more solder balls.

In some embodiments, the electrical connection material may be one or more bumps or copper pillars.

In some embodiments, a thickness of the glass-based photonic bridge may be between 30 microns and 200 microns.

In some embodiments, a thickness of the glass-based photonic bridge may be between 50 microns and 100 microns.

In some embodiments, the at least one micro-hole may be cylindrical or hourglass in shape.

In some embodiments, a diameter of the at least one micro-hole may be between 20 microns and 100 microns.

In some embodiments, the at least one micro-hole may be an elongated cutout.

In another example embodiment, a method of packaging a glass-based photonic bridge is provided. The method includes providing the glass-based photonic bridge, and the glass-based photonic bridge includes a first side, a second side opposite the first side, at least one optical waveguide, and at least one micro-hole extending between the first side and the second side. The method also includes bonding the first side of the glass-based photonic bridge to a first substrate, positioning an electrical connection material at least partially within the at least one micro-hole of the glass-based photonic bridge, and positioning the second side of the glass-based photonic bridge adjacent to a second substrate to enable electronic connection between the first substrate and the second substrate through the at least one micro-hole.

In some embodiments, the first substrate may be at least one of a wafer or a die, and the at least one optical waveguide may be disposed on the first side of the glass-based photonic bridge.

In some embodiments, the second substrate may be at least one of a wafer or a die, and the at least one optical waveguide may be disposed on the second side of the glass-based photonic bridge.

In some embodiments, the method may further include adding under-bump metallization to at least one of the first substrate or the second substrate.

In some embodiments, the electrical connection material may be one or more solder balls.

In some embodiments, the method may further include thinning the glass-based photonic bridge by polishing or etching.

In some embodiments, the electrical connection material may be one or more bumps or copper pillars.

In some embodiments, the method may further include attaching fiber connector receptacles at edges of the glass-based photonic bridge.

In another example embodiment, a glass-based photonic bridge assembly is provided. The glass-based photonic bridge assembly includes a glass-based photonic bridge including a first side, a second side opposite the first side, a first optical waveguide disposed on the first side, a second optical waveguide disposed on the first side, and a plurality of micro-holes extending between the first side and the second side. The glass-based photonic bridge assembly also includes a first die bonded to the first side of the glass-based photonic bridge, and the first die is aligned with the first optical waveguide. The glass-based photonic bridge assembly also includes a second die bonded to the first side of the glass-based photonic bridge, and the second die is aligned with the second optical waveguide. The glass-based photonic bridge assembly also includes a substrate positioned adjacent to the second side of the glass-based photonic bridge and connected to the first die and the second die by way of an electrical connection material disposed at least partially within the plurality of micro-holes.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 shows a cross-sectional view of an example glass-based photonic bridge with micro-holes, in accordance with some embodiments disclosed herein;

FIGS. 2A-2D illustrate an example process of packaging a glass-based photonic bridge in which the glass-based photonic bridge is bonded to a wafer that includes a first die and a second die, in accordance with some embodiments disclosed herein;

FIGS. 3A-3B show example flowcharts of first and second concepts for executing example packaging processes, such as the process illustrated in FIGS. 2A-2D, in accordance with some embodiments disclosed herein;

FIGS. 4A-4C illustrate an example process of packaging a glass-based photonic bridge in which the glass-based photonic bridge is bonded to a substrate, in accordance with some embodiments disclosed herein; and

FIG. 5 is an example flowchart of a method of packaging a glass-based photonic bridge, in accordance with some embodiments disclosed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

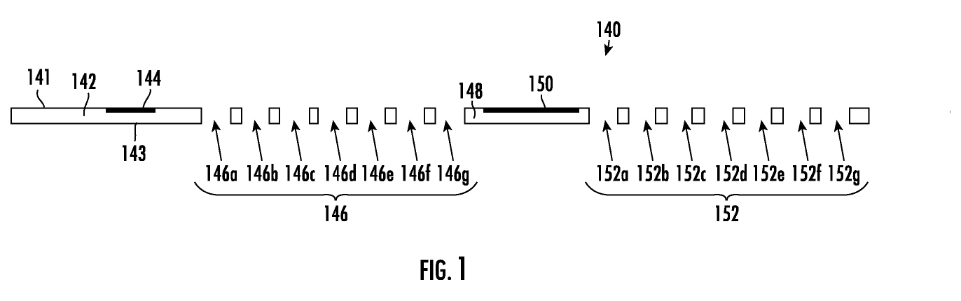

FIG. 1 shows a cross-section of an example glass-based photonic bridge 140 (e.g., an interposer) having a first side 141 and a second side 143.The second side 143 is opposite the first side 141. The glass-based photonic bridge 140 includes a first plurality of micro-holes 146 (formed of distinct micro-holes 146a-g) and a second plurality of micro-holes 152 (formed of distinct micro-holes 152a-g). On a first portion 142 of the glass-based photonic bridge 140 having no micro-holes, and on the first side 141, is a first optical waveguide 144, and on a second portion 148 of the glass-based photonic bridge 140 having no micro-holes, and on the first side 141, is a second optical waveguide 150. The first optical waveguide 144 and the second optical waveguide 150 can be integrated within the glass-based photonic bridge 140, can be disposed on the glass-based photonic bridge 140, or can be incorporated with the glass-based photonic bridge 140 in any other way. For example, while a slice of a cross-section of the glass-based photonic bridge 140 is shown, it should be appreciated the example glass-based photonic bridge 140 extends into and out of the page, and glass is formed around the micro-holes 146, 152 such that a single integrated glass substrate forms the glass-based photonic bridge 140. Along these lines, in some embodiments, different configurations, positions, shapes, and sizes of micro-holes can be utilized. Likewise, different configurations of optical waveguides may be used. Such optical waveguides can extend in any configuration on the first side 141, such as around the micro-holes among other configurations. Further, in some embodiments, the first optical waveguide 144 and the second optical waveguide 150 could be ion-exchange waveguides, fs-laser written waveguides, or any other types of waveguides.

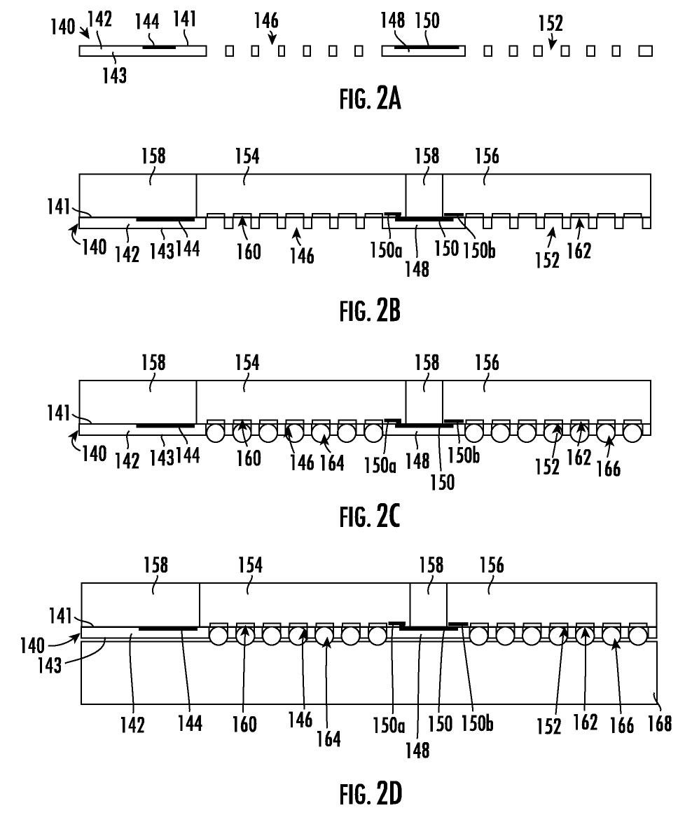

As will be described in more detail with respect to FIGS. 2A-2D, the first optical waveguide 144 and the second optical waveguide 150 may be configured to connect with and/or bond to at least one substrate, e.g., a first die and a second die, which may or may not be included within a wafer. For example, the glass-based photonic bridge 140 may have alignment features (e.g., detents, indicators, etc.) that cause the first optical waveguide 144 to align with a first die and cause the second optical waveguide 150 to align with a second die. In this way, the first optical waveguide 144 and the second optical waveguide 150 of the glass-based photonic bridge 140 may interconnect the first die and the second die. Other configurations are also contemplated within the scope of this disclosure.

It should be appreciated that, although the embodiment shown in FIG. 1 includes two optical waveguides, in other embodiments, a glass-based photonic bridge may include more optical waveguides, or one optical waveguide, and the one or more optical waveguides may be configured differently. For example, one or more optical waveguides may be disposed on a second side (such as the second side 143) of a glass-based photonic bridge, integrated within an inner portion of a glass-based photonic bridge, or configured any other way.

The first plurality of micro-holes 146 may include a first micro-hole 146a, a second micro-hole 146b, a third micro-hole 146c, a fourth micro-hole 146d, a fifth micro-hole 146e, a sixth micro-hole 146f, and a seventh micro-hole 146g. Similarly, the second plurality of micro-holes 152 may include a first micro-hole 152a, a second micro-hole 152b, a third micro-hole 152c, a fourth micro-hole 152d, a fifth micro-hole 152e, a sixth micro-hole 152f, and a seventh micro-hole 152g. Each of the micro-holes may extend between the first side 141 and the second side 143 of the glass-based photonic bridge 140 and may be configured to receive an electrical connection material therein extending through the micro-hole for electrical connection between a first substrate adjacent the first side 141 and a second substrate adjacent the second side 143 (shown in FIGS. 2C-2D).

It should be appreciated that, although the embodiment shown in FIG. 1 has the first plurality of micro-holes 146 (e.g., 7 micro-holes) and the second plurality of micro-holes 152 (e.g., 7 micro-holes), in other embodiments, a glass-based photonic bridge may have more or less micro-holes. For example, in some embodiments, a glass-based photonic bridge may have only one micro-hole (e.g., a relatively large micro-hole for receiving multiple electrical connections therethrough), or in some other embodiments, a glass-based photonic bridge may have one larger micro-hole (e.g., in place of the first plurality of micro-holes 146) and then a second plurality of smaller micro-holes (e.g., similar to the second plurality of micro-holes 152). Further, in some other embodiments, a glass-based photonic bridge may have more or less pluralities of micro-holes than the first plurality of micro-holes 146 and the second plurality of micro-holes 152 shown in FIG. 1, and/or each of the pluralities of micro-holes may include more or less micro-holes than that shown in FIG. 1 (e.g., may have more or less than 7 micro-holes within each plurality of micro-holes). In some embodiments, a glass-based photonic bridge may have two micro-holes that are spaced apart, and an optical waveguide may be positioned between the two micro-holes. It should be appreciated that any configuration of micro-hole(s) is contemplated within the scope of this disclosure.

Further, the one or more micro-holes may have any shape. For example, in some embodiments, the first plurality of micro-holes 146 and the second plurality of micro-holes 152 may each be cylindrical or hourglass in shape, and in other embodiments, the first plurality of micro-holes 146 and the second plurality of micro-holes 152 may have any other shape (e.g., rectangular, triangular, irregularly shaped, etc.). Further, the first plurality of micro-holes 146 and the second plurality of micro-holes 152 may have any size. For example, a diameter of each of the first plurality of micro-holes 146 and the second plurality of micro-holes 152 may be between 20 microns and 100 microns. Alternatively, a micro-hole may, in some embodiments, be an elongated cutout that has a length that is longer than 50 microns and/or longer than 100 microns. It should be appreciated, however, that any diameter or size of a micro-hole is contemplated within the scope of this disclosure.

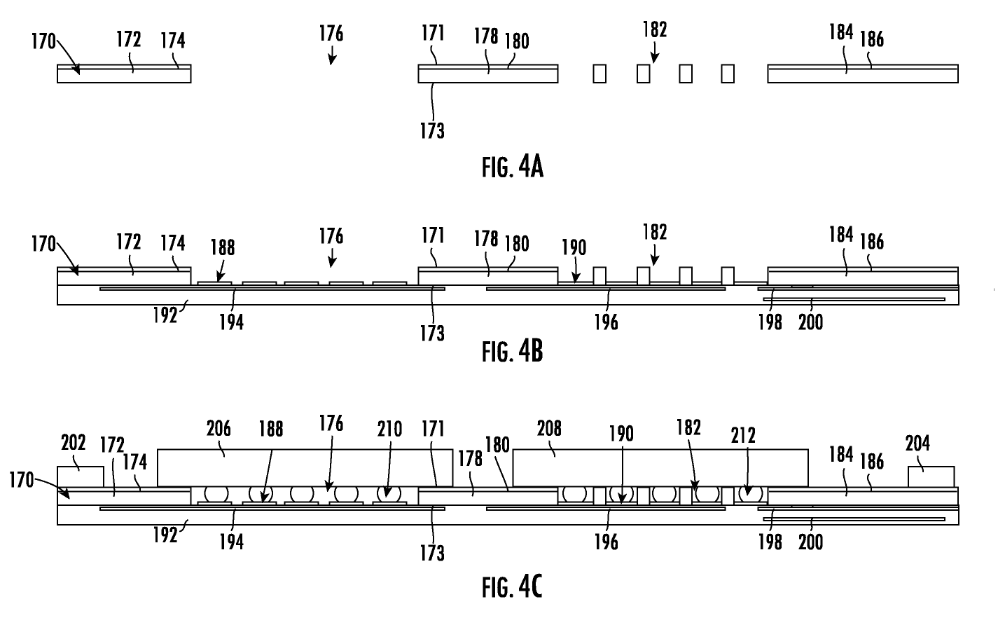

As will be described in more detail herein with respect to FIGS. 2A-2D and 4A-4C, a second substrate 168, 192 (e.g., an organic printed circuit board (PCB), silicon or glass interposer) may be positioned on the second side 143 of the glass-based photonic bridge 140, and one or more electrical connection materials may be disposed at least partially within the first plurality of micro-holes 146 and the second plurality of micro-holes 152 such that the first substrate and the second substrate are connected. In some embodiments, for example, the electrical connection materials may be solder balls, copper pillars, bumps, or any other electrical connection material.

In some embodiments, a thickness of the glass-based photonic bridge 140 may be less than 50 microns. Further, in some embodiments, if thicker glass is used (e.g., for handling reasons due to size or material availability), the glass of the glass-based photonic bridge 140 may be thinned by polishing (e.g., CMP (Chemical Mechanical Polishing)) or etching (e.g., HF). The thinness (and other features) of the glass-based photonic bridge 140 may cause the glass-based photonic bridge 140 to be flexible, which may be advantageous in many embodiments, especially in view of current solutions, which are not flexible. As an example, in some embodiments, a thickness of the glass-based photonic bridge 140 may be between 30 microns and 200 microns and/or between 50 microns and 100 microns. However, other thicknesses are also contemplated within the scope of this disclosure.

FIGS. 2A-2D illustrate an example process of packaging the glass-based photonic bridge 140. As shown in FIG. 2A, the process includes providing the glass-based photonic bridge 140 of FIG. 1. As shown in FIG. 2B, the process involves bonding a first substrate (e.g., wafer 158) to the first side 141 of the glass-based photonic bridge 140. The bonding may be direct bonding, adhesive, bonding, or any other type of bonding. In the embodiment shown in FIGS. 2A-2D, the first substrate is a wafer 158 comprising a first die 154 and a second die 156. For example, in some embodiments, the first die 154 and the second die 156 may be photonic integrated circuits (PICs) or other substrates. As also shown in FIG. 2B, the process may also optionally include adding first under-bump metallization 160 to the first die 154 and second under-bump metallization 162 the second die 156. The first die 154 may include a third waveguide 150a configured to communicate with the second waveguide 150 of the glass-based photonic bridge 140, and the second die 156 may include a fourth waveguide 150b that is also configured to communicate with the second waveguide 150 of the glass-based photonic bridge 140. Although the first waveguide 144, the second waveguide 150, the third waveguide 150a, and the fourth waveguide 150b shown in FIGS. 2A-2D are linearly aligned and are configured to lay in a parallel pattern with respect to each other, in other embodiments, waveguides may be configured differently. For example, waveguides may be more complexly aligned (e.g., waveguides may pass over and/or around one or more dies).

It should be appreciated that, although the embodiment shown in FIGS. 2A-2D shows a wafer 158 that includes a first die 154 and a second die 156, in other embodiments, the first die 154 and the second die 156 could be bonded to the glass-based photonic bridge 140 with no wafer. Further, in some embodiments, the wafer 158 can be replaced by a heterogeneous target wafer after a transfer printing process. The wafer 158 may be a system-in-package (SiP) wafer or any other type of wafer.

As shown in FIG. 2C, the process may include positioning first electrical connection material 164 within the first plurality of micro-holes 146 and positioning second electrical connection material 166 within the second plurality of micro-holes 152. As shown in FIG. 2D, the process may include positioning a substrate 168 on the second side 143 of the glass-based photonic bridge 140. The first plurality of micro-holes 146 may thus receive the first electrical connection material 164 therein extending through the first plurality of micro-holes 146 for electrical connection between the wafer 158 comprising the first die 154 and the second die 156 adjacent the first side 141 and the substrate 168 adjacent the second side 143.

In some embodiments, the wafer 158, the first die 154, and the second die 156 may define a footprint, and the first plurality of micro-holes 146 and the second plurality of micro-holes 152 may be positioned within the footprint when the first electrical connection material 164 and the second electrical connection material 166 are received by the first plurality of micro-holes 146 and the second plurality of micro-holes 152 for electrical connection between the first die 154, the second die 156, and the substrate 168.

The optical interface can be, for example, evanescent, out of plane (e.g. grating, mirror) or edge coupled. With this approach, different dies can be attached to the glass-based photonic bridge 140, and the assembly can include photonic interconnections as well as electrical interconnections for signal processing, memory, sensing or other applications and needs.

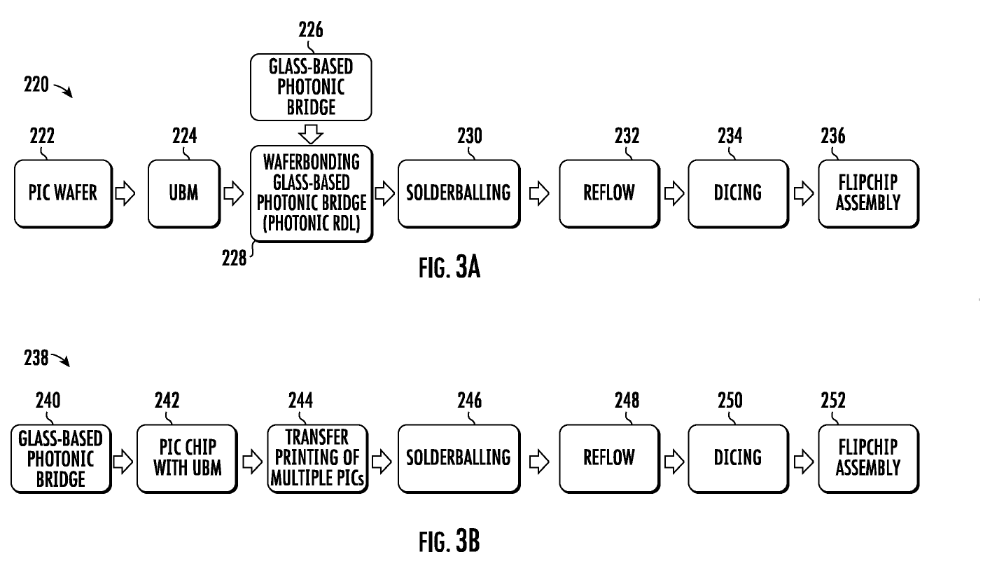

FIGS. 3A-3B show a first packaging flow concept 220 and a second packaging flow concept 238. As shown in FIG. 3A, the first packaging flow concept 220 begins by providing a PIC wafer at 222 and then adding under-bump metallization to the wafer at 224. A glass-based photonic bridge 226 is then bonded at 228 using a wafer bonding process. At 230, solder balls are attached through micro-hole(s) of the glass-based photonic bridge 226. At 232, a reflow process is executed. For example, the reflow process at 232 may include applying solder paste to contact pads of a PCB, placing components on, and then melting the solder paste with heated air to join the electrical components. The solder “reflows” to make the connection. At 234, a dicing process may be executed. For example, the dicing process at 234 may include separating die from the PIC wafer following the processing of the PIC wafer. The dicing process may involve scribing and breaking, mechanical sawing, laser cutting, and/or any other separation method. After dicing, the resulting multiple die modules (along with the glass-based photonic bridge) can be attached to the final substrate using a standard flip chip process at 236. The first packaging flow concept 220 enables a best selection regarding performance and cost for the glass-based photonic bridge (e.g., glass with low-loss waveguides) and non-optical electrical material, such as organic printed circuit boards (PCBs) or others dependent on application.

As shown in FIG. 3B, the second packaging flow concept 238 may use a glass-based photonic bridge 240 as a target wafer. At 242, under-bump metallization is applied, and singulated photonic integrated circuits (or die) are populated onto the glass-based photonic bridge 240 to create optical connections. Transfer printing is executed at 244, and then the assembled package follows a similar process flow like the first packaging flow concept 220. For example, at 246, solder balls are attached through micro-hole(s) of the glass-based photonic bridge 240. At 248, a reflow process is executed. For example, the reflow process at 248 may include applying solder paste to contact pads of a PCB, placing components on, and then melting the solder paste with heated air to join the electrical components. The solder “reflows” to make the connection. At 250, a dicing process may be executed. For example, the dicing process at 250 may include separating the photonic integrated circuits. The dicing process may involve scribing and breaking, mechanical sawing, laser cutting, or any other separation method. After dicing, the resulting multiple die modules can be attached to the final substrate using a standard flip chip process at 252.

FIGS. 4A-4C show a process of packaging another example glass-based photonic bridge 170. This process combines the glass-based photonic bridge 170, which is for optical interconnection, and an established electrical substrate 192 such as an organic printed circuit board, silicon or glass interposer. As shown in FIG. 4A, the process includes providing the glass-based photonic bridge 170 (shown in cross-section-like form with portions that would otherwise appear where the micro-holes are being removed for clarity), which includes a first side 171 and a second side 173. On the first side 171 are a first optical waveguide 174, a second optical waveguide 180, and a third optical waveguide 186. The first optical waveguide 174 is positioned on a first portion 172 of the glass-based photonic bridge 170, the second optical waveguide 180 is positioned on a second portion 178 of the glass-based photonic bridge 170, and the third optical waveguide 186 is positioned on a third portion 184 of the glass-based photonic bridge 170. Between the first portion 172 and the second portion 178 is a single micro-hole 176, and between the second portion 178 and the third portion 184 is a plurality of micro-holes 182.

As shown in FIG. 4B, the process includes bonding the substrate 192 to the second side 173 of the glass-based photonic bridge 170. The substrate 192 may include integrated waveguides 194, 196, 198, and 200. First under-bump metallization 188 and second under-bump metallization 190 may be applied onto the substrate 192 as well.

As shown in FIG. 4C, a first die 206 and a second die 208 are attached, and electrical connection material 210 and 212, such as bumps or copper pillars, are positioned through the micro-holes 176 and 182 in the glass-based photonic bridge 170 to make contact with the under-bump metallization 188 and 190 on the substrate 192. The first die 206 and the second die 208 can be pressed down so that surfaces of the first die 206, the second die 208, and the glass-based photonic bridge 170 are in contact for evanescent coupling between waveguides 174, 180, and 186 of the photonic bridge 170 and integrated waveguides in the first die 206 and the second die 208 (note that the integrated waveguides of the first die 206 and the second die 208 are not illustrated in FIG. 4C, but example such waveguides are shown and described with respect to FIGS. 2B-D). Further, in some embodiments, a first fiber connector receptacle 202 and a second fiber connector receptacle 204 may be attached for fiber to waveguide connectivity at edges of the glass-based photonic bridge 170.

### Example Flowchart(s)

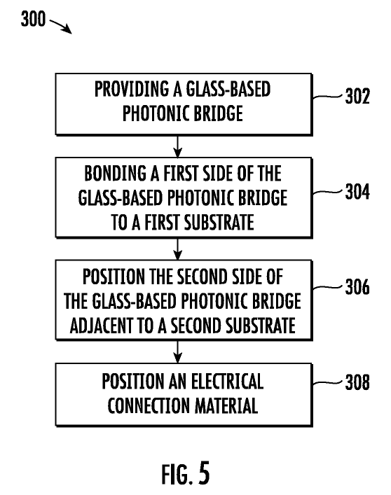

FIG. 5 illustrates a flowchart according to an example method 300 of packaging a glass-based photonic bridge according to an example embodiment. The method 300 may include providing the glass-based photonic bridge at operation 302. The glass-based photonic bridge provided at operation 302 may include a first side, a second side opposite the first side, at least one optical waveguide, and at least one micro-hole extending between the first side and the second side.

At operation 304, the method 300 may include bonding the first side of the glass-based photonic bridge to a first substrate. In some embodiments, for example, the first substrate may be at least one of a wafer or a die, and the at least one optical waveguide may be disposed on the first side of the glass-based photonic bridge. In other embodiments, however, the first substrate may be an organic substrate such as an organic PCB, silicon or glass interposer.

At operation 306, the method 300 may include positioning the second side of the glass-based photonic bridge adjacent to a second substrate. In some embodiments, such as embodiments in which the first substrate is at least one of a wafer or a die and the at least one optical waveguide is disposed on the first side of the glass-based photonic bridge, the second substrate may be an organic substrate such as an organic PCB, silicon or glass interposer. In other embodiments, such as embodiments in which the first substrate is an organic substrate such as an organic PCB, silicon or glass interposer, the second substrate may be at least one of a wafer or a die, and the at least one optical waveguide may be disposed on the first side of the glass-based photonic bridge.

At operation 308, the method 300 may include positioning an electrical connection material at least partially within the at least one micro-hole of the glass-based photonic bridge. In some embodiments, for example, the electrical connection material may be one or more solder balls, bumps, and/or copper pillars. Thereafter, the second side of the glass-based photonic bridge may be attached and/or brought up against the second substrate to complete the electrical connection between the first substrate and the second substrate via the electrical connection material within the at least one micro-hole.

Additional manufacturing operations and/or additional usage operations are also contemplated. For example, the method 300 may also include thinning the glass-based photonic bridge by polishing or etching, attaching fiber connector receptacles at edges of the glass-based photonic bridge, and/or adding under-bump metallization to at least one of the first substrate or the second substrate, among other operations.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

### Conclusion

Many modifications and other embodiments of the disclosures set forth herein may come to mind to one skilled in the art to which these disclosures pertain having the benefit of the teachings presented in the foregoing descriptions and the associated drawings. Therefore, it is to be understood that the embodiments of the disclosure are not to be limited to the specific embodiments disclosed and that modifications and other embodiments are intended to be included within the scope of the disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

Claims:

1. A glass-based photonic bridge comprising:
a first side;
a second side opposite the first side;
at least one optical waveguide disposed on the first side; and
at least one micro-hole extending between the first side and the second side, the at least one micro-hole being configured to receive an electrical connection material therein extending through the at least one micro-hole for electrical connection between a first substrate adjacent the first side and a second substrate adjacent the second side.

2. The glass-based photonic bridge of claim 1, wherein the glass-based photonic bridge is configured to be packaged with at least one substrate and at least one of a wafer or a die.

3. The glass-based photonic bridge of claim 1, wherein the first substrate defines a footprint, and wherein the at least one micro-hole is positioned within the footprint when the electrical connection material is received by the at least one micro-hole for electrical connection between the first substrate and the second substrate.

4. The glass-based photonic bridge of claim 1, wherein the at least one micro-hole is two micro-holes that are spaced apart, and wherein the at least one optical waveguide is positioned between the two micro-holes.

5. The glass-based photonic bridge of claim 1, wherein the glass-based photonic bridge is flexible.

6. The glass-based photonic bridge of claim 1, wherein the at least one micro-hole is a plurality of micro-holes.

7. The glass-based photonic bridge of claim 1, wherein the electrical connection material is one or more solder balls.

8. The glass-based photonic bridge of claim 1, wherein the electrical connection material is one or more bumps or copper pillars.

9. The glass-based photonic bridge of claim 1, wherein a thickness of the glass-based photonic bridge is between 30 microns and 200 microns.

10. The glass-based photonic bridge of claim 1, wherein a thickness of the glass-based photonic bridge is between 50 microns and 100 microns.

11. The glass-based photonic bridge of claim 1, wherein the at least one micro-hole is cylindrical or hourglass in shape.

12. The glass-based photonic bridge of claim 1, wherein a diameter of the at least one micro-hole is between 20 microns and 100 microns.

13. A method of packaging a glass-based photonic bridge, the method comprising:
providing the glass-based photonic bridge, the glass-based photonic bridge comprising:
a first side;
a second side opposite the first side;
at least one optical waveguide; and
at least one micro-hole extending between the first side and the second side;
bonding the first side of the glass-based photonic bridge to a first substrate;
positioning an electrical connection material at least partially within the at least one micro-hole of the glass-based photonic bridge; and
positioning the second side of the glass-based photonic bridge adjacent to a second substrate to enable electronic connection between the first substrate and the second substrate through the at least one micro-hole.

14. The method of claim 13, wherein the first substrate is at least one of a wafer or a die, and wherein the at least one optical waveguide is disposed on the first side of the glass-based photonic bridge.

15. The method of claim 14, wherein the at least one optical waveguide extends on the first side between a first micro-hole and a second micro-hole, wherein the first micro-hole is spaced apart from the second micro-hole on the first side.

16. The method of claim 13, wherein the second substrate is at least one of a wafer or a die, and wherein the at least one optical waveguide is disposed on the second side of the glass-based photonic bridge.

17. The method of claim 13, wherein the method further comprises adding under-bump metallization to at least one of the first substrate or the second substrate.

18. The method of claim 13, wherein the method further comprises thinning the glass-based photonic bridge by polishing or etching.

19. The method of claim 13, wherein the method further comprises attaching fiber connector receptacles at edges of the glass-based photonic bridge.

20. A glass-based photonic bridge assembly comprising:
a glass-based photonic bridge comprising:
a first side;
a second side opposite the first side;
a first optical waveguide disposed on the first side;
a second optical waveguide disposed on the first side; and
a plurality of micro-holes extending between the first side and the second side;
a first die bonded to the first side of the glass-based photonic bridge, wherein the first die is aligned with the first optical waveguide;
a second die bonded to the first side of the glass-based photonic bridge, wherein the second die is aligned with the second optical waveguide; and
a substrate positioned adjacent to the second side of the glass-based photonic bridge and connected to the first die and the second die by way of an electrical connection material disposed at least partially within the plurality of micro-holes.
